(19) United States
(12) Patent Application Publication
(10) Pub. No.: US 2005/0177773 A1
(43) Pub. Date: Aug. 11, 2005

(54) Software method for exhaustive variation of parameters, independent of type

(76) Inventors: Andrew Hadley, Colorado Springs, CO (US); David So, Colorado Springs, CO (US); Mark Slutz, Colorado Springs, CO (US)

Correspondence Address: LSI LOGIC CORPORATION, 1621 BARBER LANE, MS: D-106, MILPITAS, CA, 95035, US

(21) Appl. No.: 10/762,621

(22) Filed: Jan. 22, 2004

(51) Int. Cl. G06F 11/00

(52) U.S. Cl. 714/38

(57) ABSTRACT

A method, system, and computer readable medium varies parameter data for a device under test. Parameters may be successively retrieved and set to a specified or random value. A state machine for operating, testing, and/or simulating a device under test using common code that is function specific. The state machine is built through inputting parameter information into the common code. Each state of the state machine has a unique set of parameters that define the state of the machine at that state. Pointers and status functions are preferably used to build and maintain the state machine.

### FIELD OF THE INVENTION

The present invention generally relates to the field of validation software, and particularly to a software method for exhaustive variation of parameters that are independent of type.

### BACKGROUND OF THE INVENTION

There are many parameters that need to be varied to fully test hardware under test. Validation software that tests the functionality of the hardware may use parameters such as Peripheral Component Interconnect (PCI) cache line size, Small Computer System Interface (SCSI) synchronous rate, and block size. Over time, the hardware to be tested has grown in complexity. With the increased complexity, the different combinations of parameters become more unmanageable and extremely time consuming to implement in code. Current solutions are limited in that each parameter is treated separately and is varied within its predetermined bounds. The code used to implement each individual parameter is further limiting in that it is unique for each parameter. The unique code includes sections or subroutines for editing the parameter, storing the parameter into a configuration save file, displaying the parameter to the user, and varying the parameter during a test execution.

Therefore, it would be desirable to provide a method, computer readable medium, and system to permit complex hardware testing for current and future devices in a more manageable time efficient way.

### SUMMARY OF THE INVENTION

Accordingly, the present invention is directed to a method, computer readable medium, and system for generating a state machine that is able to easily add, change, and delete states and vary the parameters of operating, testing, and/or simulating a hardware device.

In order to allow the developer to transparently implement new parameters, a level of abstraction is applied to the parameters. Once this level of abstraction is applied to the parameters, then common code may be assigned for each function, such as display, edit, store, load, and varying the parameters. In the present invention, adding new parameters into a validation or other software application is greatly simplified. New parameters may be added quickly and without knowledge of details on displaying, editing, storing, loading, and varying. With the present invention, varying a parameter is facilitated and the parameter state machine needs to be tested only once. Coding efforts are reduced to a bare minimum when adding new parameters. Errors induced by adding new parameters are minimized due to the common code handling of these parameters. The present invention also removes the dependence of existing parameters on the newly added parameters.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIGS. 1A, 1B, and 1C illustrate an embodiment of a method of the present invention; and

FIG. 2 illustrates an embodiment of a system of the present invention.

### DETAILED DESCRIPTION OF THE INVENTION

Reference will now be made in detail to the presently preferred embodiments of the invention, examples of which are illustrated in the accompanying drawings.

The present invention relates to a method, system, and computer readable medium for generating a state machine and operating, testing, and simulating a device under test using common code that is function specific. The present invention is especially directed to system level validation of new silicon, such as found in new Small Computer System Interface (SCSI) controllers and new Fibre Channel (FC) controllers. The present invention allows exhaustive testing of the silicon in a number of host bus configurations, such as Peripheral Component Interconnect (PCI) and PCI Extended (PCIX), with a number of parameters, such as 32 bit or 64 bit operation or speeds of 33 MHz or 66 MHz. Every combination of SCSI protocol conditions may be tested, including SCSI bus speeds, widths, and offsets with various data patterns. SCSI parameters (e.g., synchronous bus reads, synchronous bus widths, synchronous offsets, data patterns) may be intermixed with PCI specific bus parameters (e.g., timers). The state machine is built through inputting parameter information into the common code and is independent of bus type—such as SCSI, FC, and PCI. The state machine can step through all possible combinations of parameters to test the way the silicon behaves. The parameters may have a default set of values and are subject to boundary conditions. With the present invention, a new parameter (SCSI, FC, iSCSI, PCI) may be added with minimal development effort. An algorithm advances the state machine from a current state to a next state. The present invention preferably uses pointers and status functions to build and maintain the state machine. Each function may have its own state machine or a single state machine may include multiple functions. In the embodiment where each function has its own state machine, other code may be used to interrelate two or more such state machines. Each parameter may be independent of type.

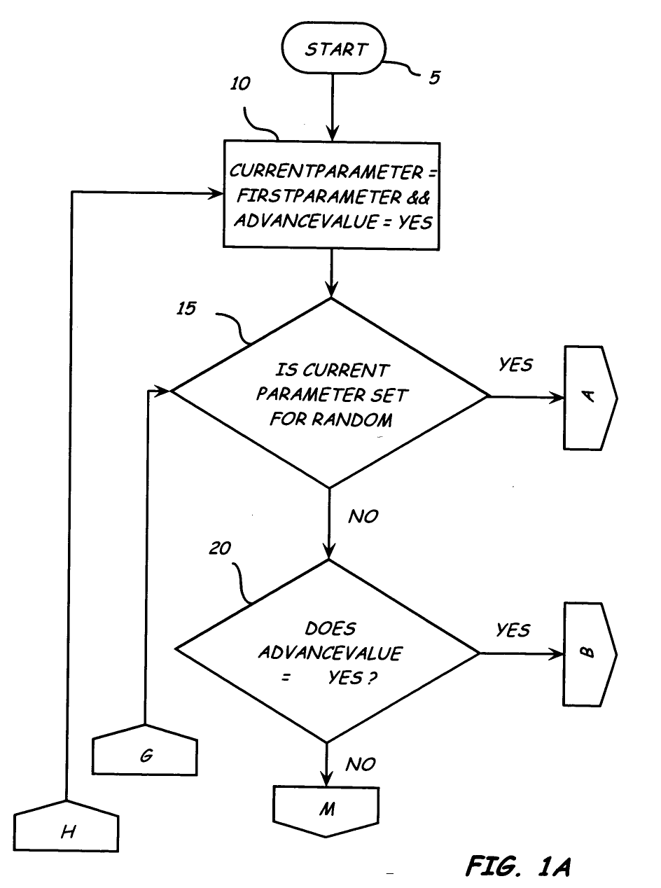

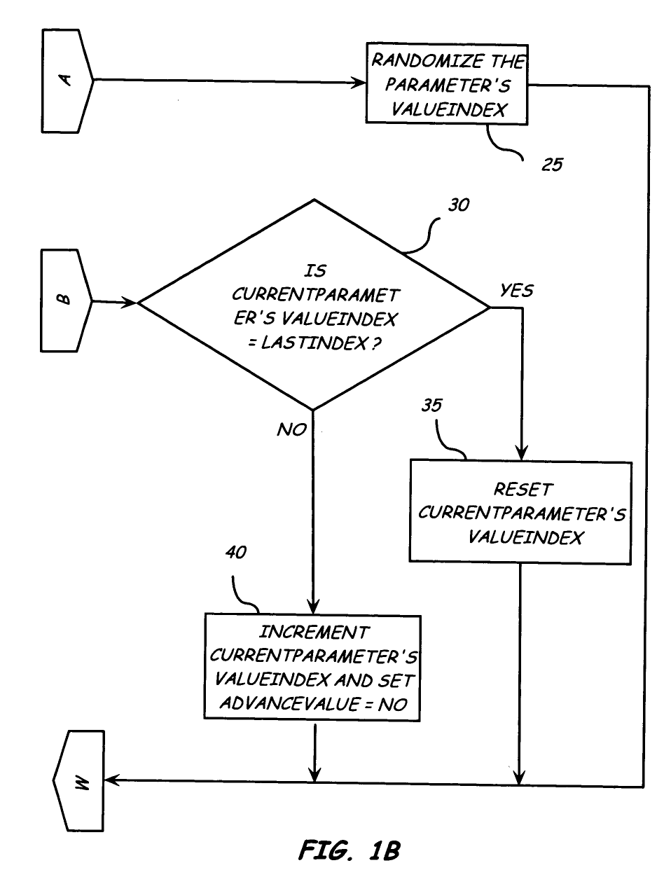

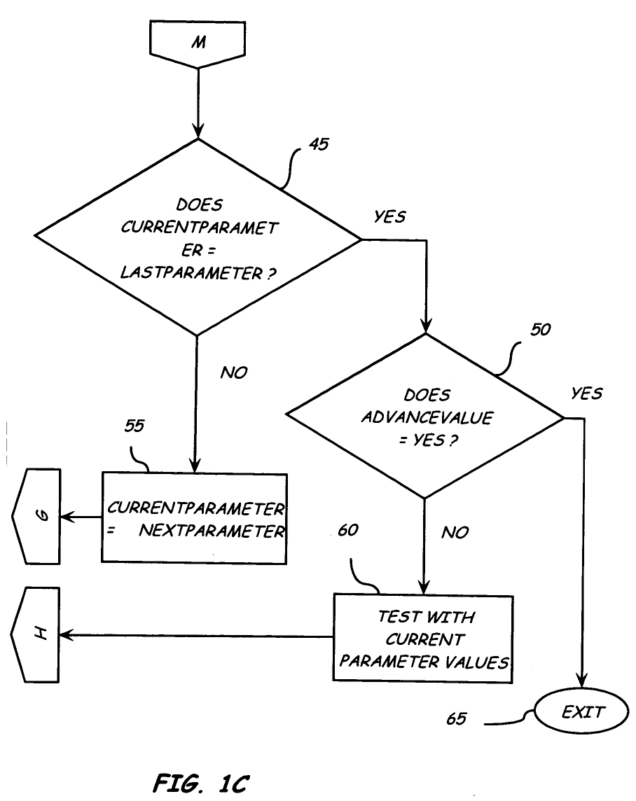

FIGS. 1A, 1B, and 1C illustrate an embodiment of a method of the present invention. Basically, the method loads all the parameters for a given test, randomizing values for specified parameters as indicated, until all parameters for the test have had values assigned. As shown in FIG. 1A, initially 5, the current parameter of a list of parameters for a function is retrieved 10. The advance flag, used to designate the end of testing, is set 10 to indicate a parameter loading phase. A determination is made as to whether the current parameter is set as a random value 15. If it is, a random number is selected for the current parameters value 25 and processing proceeds to step 45. The random number may be generated by a random number generator or could be derived from a table of available values in which an index is randomly generated. At step 45, a determination is made as to whether the current parameter is the last parameter of the function, subroutine, or the like. If the current parameter is not the last parameter, the current parameter is set to the next parameter value 55 and processing proceeds to step 15. Otherwise, a determination is made as to whether the end of testing has been reached 50. If the end of testing is determined to have been reached, then testing is terminated 65. Otherwise, testing commences with the updated current parameter values 60. After testing, processing returns to step 10 where another current parameter value is assigned. If, at step 15, the determination is that the current parameter is not set for a random value, then a determination is made as to whether the end of testing has been reached by a set value of the advance value flag 20. If the advance value flag has been set (i.e., equal to YES), then a determination is made as to whether the current parameter's value index is equal to the last index 30. That is, a determination is made as to whether there is another parameter to retrieve 30. If the current parameter's value index is equal to the last index, the current parameter's value index is reset or cleared 35. Otherwise, the current parameter's value index is incremented and the advance value flag is cleared 40, indicating that testing is to continue. Processing then proceeds to step 45. Each parameter is assigned a type (e.g., BOOLEAN, LIST, RANGE, INCREMENTAL STEP SIZE, CHARACTER, INTEGER, UNSIGNED INTEGER, FLOATING POINT, STRING, POINTER). Values, attributes, and the like may be set for the parameter.

In the present invention, the parameter that can contain a set number of values that the user has set up. For example, if the user would like to setup a test with a Sync Rate of 40, 80, 160 and a Sync Offset of 1-9,15,31-47. The state machine would progress through a series of these combinations, such as
SR(sync rate)=40 SO(sync offset)=1
SR=80 SO=1
SR=160 (last parameter is set for SR!) SO=1
SR=40 SO=2
SR=80 SO=2
SO=160 (last parameter is set for SR!) SO=2
SO=40 SO=3 and so on. The parameter state machine could terminate as follows
SR=80 SO=46
SR=160 (last parameter is set for SR!) SO=46
SR=40 SO=47
SR=80 SO=47
SR=160 (last parameter is set for SR!) SO=47 (last parameter is set for SO!)
   The value is advanced from 40 to 80 to 160. The current parameter is reset from 160 to 40. The parameter's index is simply a variable that increments the parameter value. Changing from 40 to 80 to 160 advances the parameter's index.

Various types of coding may be used set up a state machine in the present invention. A set of token definitions facilitates inter software module communications and facilitates management of the states. Each state may include one or more parameters. Various functions allow flexibility to the number, type, and value of parameters in a state machine. These functions allow the tracking of dead states, removed states, copy states, revived states, free states, and active states. Initialization and parameter validation are performed. There may be functions that permit changing the type of parameter, copying a parameter, changing a range of a parameter, changing an incremental step size of a parameter, and individually listing each value in a range of values for a parameter to permit a greater variety of parameter behavior. A random number generator may be used. The state changes may be logged in a log file. A tagging function may be used to verify the validity of addresses. A parsing function preferably is used to identify parameters in a string.

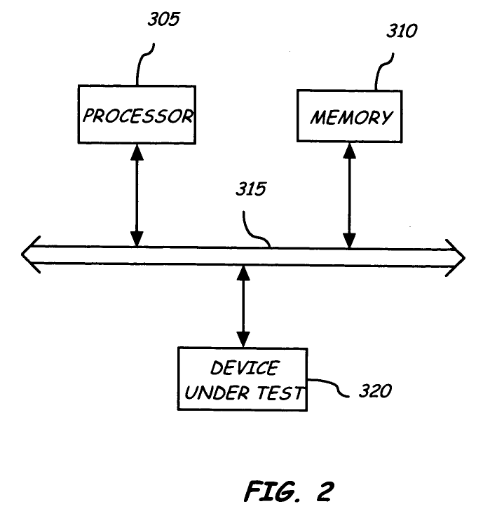

FIG. 2 illustrates an embodiment of a system of the present invention. A processor 305 retrieves the program instructions from a computer readable medium (e.g., memory 310) and generates a state machine. This state machine functions to test, validate, or simulate a device under test 320 through a bus 315. A graphical user interface on a display coupled to the processor may be used to permit a tester or other operator to visualize the structure of the state machine. The tester or other operator may be permitted to interactively select test routines or to vary the values during a simulation or test.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

1. A method for creating and using a state machine, comprising:
creating a first state;
creating a second state;
building a state machine from the first and second states, the state machine being capable of performing a plurality of functions; and
using common code for each of the plurality of functions, the common code not being unique for a function of a given type.

2. The method of claim 1, wherein the given type includes at least one of editing, storing, loading, and varying a parameter.

3. The method of claim 1, wherein the plurality of functions include editing, storing, loading, and varying a parameter.

4. The method of claim 1, further comprising recognizing dead states in the state machine.

5. The method of claim 4, further comprising removing dead states from the state machine.

6. The method of claim 4, further comprising reviving a dead state in the state machine.

7. The method of claim 1, further comprising estimating a number of states needed to build the state machine.

8. The method of claim 7, further comprising estimating a number of dead states in the state machine at a point in time after the state machine is built.

9. The method of claim 1, further comprising, after building the state machine, running the state machine to test a device under test.

10. The method of claim 1, further comprising, after building the state machine, running the state machine to test software under test.

11. The method of claim 1, further comprising, after building the state machine, running the state machine to simulate a device.

12. A computer readable medium having a program of instructions implemented in code, the program of instructions comprising:
creating a first state;
creating a second state;
building a state machine from the first and second states, the state machine being capable of executing at least one function, the at least one function being implemented in code common to multiple parameters.

13. The computer readable medium of claim 12, wherein the at least one function includes at least one of the group consisting of editing, storing, loading, and displaying.

14. The computer readable medium of claim 12, wherein the multiple parameters include a Peripheral Component Interconnect (PCI) cache line.

15. The computer readable medium of claim 12, wherein the multiple parameters include a Small Computer System Interface (SCSI) synchronous rate.

16. The computer readable medium of claim 12, wherein the multiple parameters include a block size.

17. The computer readable medium of claim 12, further comprising a look up table for storing default values of the multiple parameters.

18. The computer readable medium of claim 12, further comprising a look up table for providing type and value information for each of the multiple parameters.

19. The computer readable medium of claim 12, wherein the type and value information includes a range of values that are permitted for each of the multiple parameters.

20. The computer readable medium of claim 19, wherein the type and value information includes an incremental step size for each of the multiple parameters.

21. The computer readable medium of claim 12, wherein at least one of the multiple parameters is independent of type.

22. A system that behaves in accordance with a state machine, comprising:
a processor for implementing and using a state machine;
a memory coupled to the processor, the memory storing information about the state machine;
a bus; and
a device coupled to the processor via the bus, the device capable of being tested by the state machine, wherein the state machine corresponds to a function that is stored in generic parameter independent code, wherein the state machine has a current state.

23. The system of claim 22, wherein the state machine is implemented as a linked list of states.

24. The system of claim 23, wherein each of the states corresponds to a state of the state machine.

25. The system of claim 24, wherein the state machine receives inputs.

26. The system of claim 25, wherein the inputs and the current state of the state machine determine a next state and an output of the state machine.

27. The system of claim 26, wherein, for a given input, each state has a next state.

28. The system of claim 27, wherein, for the given input, each state has a next next state.

29. The system of claim 28, wherein, for the given input, each state has a previous state and a previous previous state.

30. A method for varying parameters for a device under test, comprising:
setting a current parameter to a first parameter;
setting a flag to indicate that testing is to continue; and
determining if the current parameter is to be randomized.

31. The method of claim 30, further comprising, if it is determined that the current parameter is to be randomized, then randomizing the current parameter's value index.

32. The method of claim 31, further comprising, determining if the current parameter is equal to the last parameter.

33. The method of claim 32, further comprising, if it is determined that the current parameter is not the last parameter, then setting the current parameter to the next parameter.

34. The method of claim 33, further comprising, if the flag indicates that testing is to continue, determining if the current parameter's value is equal to the last parameter.

35. The method of claim 34, further comprising, if it is determined that the current parameter is not to be randomized, then determining if the current parameter's value is equal to the last parameter.

36. The method of claim 35, further comprising, if it is determined that the current parameter is the last parameter, then checking the flag to indicate that testing is to continue.

37. The method of claim 36, further comprising, if checking the flag indicates that testing is to continue, testing the device under test with current parameter values.

38. The method of claim 36, further comprising, if checking the flag indicates that testing is not to continue, then stopping testing of the device under test.

39. The method of claim 37, further comprising, setting the current parameter to a new parameter for a new test cycle.

40. The method of claim 32, further comprising, if it is determined that the current parameter is the last parameter, then setting the current parameter to a next parameter.

41. The method of claim 40, further comprising determining if the current parameter is to be randomized.

42. The method of claim 41, wherein a function that uses the current parameter is implemented in common code.

43. The method of claim 42, wherein the current parameter is independent of type.
